(19) United States
(12) Patent Application Publication
(10) Pub. No.: US 2024/0415128 A1
(43) Pub. Date: Dec. 19, 2024

(54) COMPOSITION COMPRISING A STRAIN OF MITSUARIA NODULI

(71) Applicant: BIOINTRANT, PERTUIS (FR)

(72) Inventors: Renaud NALIN, DREMIL-LAFAGE (FR); Nicolas CHABERT, Vitrolles (FR)

(21) Appl. No.: 18/698,675

(22) PCT Filed: Oct. 3, 2022
(86) PCT No.: PCT/EP2022/077447

§ 371 Date: Apr. 4, 2024

(30) Foreign Application Priority Data
Oct. 4, 2021 (FR) FR2110486

(51) Int. Cl. A01N 63/20; A01P 21/00

(52) U.S. Cl. CPC A01N 63/20; A01P 21/00

(57) ABSTRACT

The object of the invention is a composition intended to improve the growth of plants comprising at least one strain of bacteria belonging to the species Mitsuaria noduli, preferably the strain of Mitsuaria noduli deposited at the CNCM on Jul. 30, 2021, under the number I-5724 or I-5725; and the use of such a strain as a biostimulant.

This patent application claims the priority of the French patent application FR 2110486 filed on Oct. 4, 2021, and which is incorporated into the current patent application by reference.

### FIELD OF THE INVENTION

The present invention relates to the field of agriculture and, more precisely, the use of a strain belonging to the Mitsuaria noduli species to improve plant growth.

### PRIOR ART

In the field of agriculture, increasing production yields remains a major challenge both economically and socially. In order to address this, numerous chemical or biological compositions have been developed with results that vary widely in their effectiveness. Said compositions attempt to (i) directly combat crop pests, (ii) protect plants from abiotic stress, (iii) stimulate natural defenses, and (iv) improve plant nutrition and growth.

### SUMMARY OF THE INVENTION

The inventors have now found, surprisingly, that a particular species of the genus Mitsuaria (i.e. Mitsuaria noduli) exerted significantly greater effects in terms of both the growth and protections of plants, compared to those obtained with other reference bacterial species.

The present invention thus aims to provide a novel, highly effective composition that improves plant growth.

Consequently, the first object of the invention relates to a composition comprising at least one strain of bacteria belonging to the species Mitsuaria noduli, which aims to improve the growth of plants.

Advantageously, said strain is the same strain of Mitsuaria noduli filed with the CNCM on Jul. 30, 2021, under the number I-5724 or I-5725.

A second object of the invention relates to a method for enhancing plant growth that includes a step of direct application to the plant's seed, soil, roots, or leaves by spraying a composition (described previously).

Advantageously, the method according to the invention is intended to improve the growth of plants under water stress.

Typically, this improvement can occur via:
1) improving yields for rapeseed, strawberries, and even basil.
2) improving the nutrition of the strawberry plant.
3) improving sunflower flowering.
4) improving rapeseed root growth.

A third object of the invention relates to the use of a bacterial strain belonging to the Mitsuaria noduli species as a biostimulant.

Advantageously, said biostimulant acts as a biostimulant under water stress.

Typically, this biostimulant is intended to:
1) improving yields for rapeseed, strawberries, and even basil.
2) improving the nutrition of the strawberry plant.
3) improving sunflower flowering.
4) improving rapeseed root growth.

A fourth object of the invention concerns the strains CNCM I-5724 and CNCM I5725.

### DETAILED DESCRIPTION OF THE EMBODIMENTS

The composition according to the invention typically comprises 10⁴ to 10¹² CFU/g or CFU/ml, preferably de 10⁵ à 10¹⁰ CFU/g or CFU/ml, or even more preferably 10⁶ to 10⁸ CFU/g or CFU/ml of Mitsuaria noduli.

In terms of weight, the composition according to the invention may comprise from 0.005 to 4% by weight (relative to the total weight of the composition) of Mitsuaria noduli, preferably from 0.1 to 3 by weight (relative to the total weight of the composition) of Mitsuaria noduli.

The composition according to the invention may take one of multiple forms suitable for its use as a biostimulant, such as solid forms (e.g. powders, in particular wettable powders, or granules, in particular micro-granules), liquid forms (e.g. suspensions) or gels.

The Mitsuaria noduli strain is advantageously in live form. Optionally, we can use extracts of said strain.

Also, and within the meaning of the present invention; the term biostimulant includes that of fertilizer.

The composition according to the invention may comprise at least one carrier acceptable for use in agriculture.

Such carriers are well known and include in particular talc, chalk, maltodextrin, glucose, kaolin, diatomaceous earth, chitin, alginates, and even carrageenan.

The composition according to the invention may comprise at least one other active agent.

In one particular embodiment, the composition of the invention is characterized in that it comprises at least said strain of bacteria in combination with other microorganisms (yeasts, bacteria and/or fungi) live, inactivated, or as extracts.

In another embodiment of the invention, the composition will also comprise, and with advantage, microorganisms, live or inactivated, extracts of microorganisms, fertilizers, herbicides, insecticides, fungicides, mineral solutions, and/or culture media.

The invention also relates to formulations of the composition for soil treatment, top dressing, foliar application, and/or seed dressing.

In the context of improving plant growth, the composition according to the invention can be applied repeatedly, for example every 3 to 6 weeks, preferably during seeding, sprouting, or the initial stages of flowering, which appear to be conducive to improving plant development and growth.

The application of the composition defined above, to cereal crops (wheat, barley, oats, rye); root crops (sugar beet, potato, corn); legumes (alfalfa, clover, sainfoin); grasses (ryegrass, fescue, orchard grass); oilseeds (soybean, rapeseed, broad bean, white lupine); vegetable and market garden crops; fruit orchards; viticulture and ornamental crops (flower production, nurseries for young plants) is of particular interest.

Other characteristics and advantages of the invention are given, by way of illustration, in examples below and in the single FIGURE, which reports study results on tomato plants in a growth chamber.

### EXAMPLES

1) Improved Strawberry Plant Nutrition and Yield Resulting from M. noduli Inoculation

The strawberry plants used were of the Ciflorette variety, which were planted in 9 trays including 4.3 kg of THREL (FLORANTAISE) potting soil.

An inoculum comprising the Mitsuaria noduli strain Bio T025 (CNCM I-5724) was used to inoculate 3 trays while the strain Paenibacillus polymyxa CT43 was used in 3 other trays; both strains had a concentration of 3×10⁹ CFU/liter of potting soil. The 3 remaining trays are not inoculated and served as a control.

The resulting fruit yield, number, weight, and quality were determined at the end of the cultivation. At the same time, the strains' utilization efficiency of elements present in the soil was determined by establishing the respective concentrations of said elements before and after cultivation. The results are presented in Table I below.

TABLE I

| | Mitsuaria noduli Bio | Paenibacillus polymyxa |
|---|---|---|
| Indicators | T025 (/control) | CT43 (/control) |
| Yield (%) | +17.6 | +24.3 |
| Fruit number(%) | +14.3 | +17.9 |
| Fruit weight (%) | +8.3 | +16.6 |
| Brix percentage | +2 | −5.1 |
| Azote utilization | +89.7 | +61.22 |
| efficiency (%) | | |
| Magnesium utilization | +88.8 | +66.6 |
| efficiency (%) | | |
| Potassium utilization | +82.6 | +26 |
| efficiency (%) | | |
| Phosphorus utilization | +85.7 | 57.51 |
| efficiency (%) | | |

The results demonstrate that both strains tested have an effect on yield with a parallel increase in the number of fruits. Simultaneously, an increase in plant nutrition was observed, said increase being noticeably greater with the Mitsuaria noduli Bio T025 strain. It should also be noted that a slight improvement in fruit quality (Brix percentage) was observed with the Mitsuaria noduli Bio T025 strain while a more marked decline was observed with the Paenibacillus polymyxa CT43 strain.

2) Improved Yield, Particularly Under Water Stress, of Basil Plants Resulting from M. noduli Inoculation

The basil seeds (Basilicum genovese) used were of the Eleonora variety (ENZA ZADEN).

The seeds were planted in a seed-starting mix composed of coconut fibers, peat, and perlite (FLORENTAISE), while an inoculum comprising the Paraburkholderia graminis strain Bio T119, the Mitsuaria noduli strain Bio T025 (CNCM I-5724), or the P. polymyxa strain CT43 was introduced in each tray with a concentration of 1.5×10⁹ CFU/liter of seed-starting mix. A second inoculation was then carried out with the different strains as soon as upon emergence of the basil plants' cotyledons. Said inoculation was carried out via subirrigation in order to ensure homogeneous bacterial colonization around the roots (inoculation dose: 1.5×10⁹ CFU/liter of seed-starting mix). The 3 controls were not inoculated.

On the day of transplantation, the germination percentage was determined for each conditions. The results are shown below in Table II.

TABLE II

| Inoculum | Germination % |
|---|---|
| Control | 89.6 |
| Paraburkholderia graminis Bio T119 | 100.0 |
| Mitsuaria noduli Bio T025 | 95.1 |
| Paenibacillus polymyxa CT43 | 98.6 |

The results reveal that each of the bacterial strains improved germination.

The plants were then transplanted into 20 trays containing 3.6 kg of THREL potting soil (FLORENTAISE), with 14 soil blocks per tray and each soil block containing 2 basil plants.

Inoculums of the strains Paraburkholderia graminis Bio T119, Mitsuaria noduli Bio T025 (CNCM I-5724), and Paenibacillus polymixa CT43 were used separately to inoculate 4 trays each at a concentration of 3×10⁹ CFU/liter of potting soil, and only in plants previously inoculated with the same strain. The remaining 4 trays corresponded to those not previously inoculated, which would remain uninoculated throughout the study to serve as controls.

Two distinctly different water regimes were applied to two trays of each those inoculated with a specific bacterial strain and to two control trays, with:
a control mode where the evapotranspiration was replaced 100% per day.
a water stress mode (65 ETP %) where the evapotranspiration was replaced only 65% per day.

The basil plants were cut several times (approximately one cut every 10-12 days) before the final harvest at the end of cultivation.

The yield was then determined, which was calculated in relation to the weight of dry matter per cell (g/cell). The results are presented below in Table III.

TABLE III

| | Yield under | Yield under water |
|---|---|---|
| | normal | stress conditions |
| | conditions | at 65% ETP |
| | (% compared | (% compared |
| Inoculum | to control) | to control) |
| Paraburkholderia graminis Bio T119 | +12.58 | +13.90 |
| Mitsuaria noduli Bio T025 | +14.92 | +32.39 |
| Paenibacillus polymyxa CT43 | +15.52 | +31.12 |

The results clearly demonstrate that the three strains tested each had an effect on yield. However, the inoculums of Mitsuaria noduli Bio T025 and Paenibacillus polymyxa CT43 appeared to maintain significantly greater yields in the presence of water stress.

3) Improved Rapeseed Yield Resulting from M. noduli Inoculation

Sensation winter rapeseed seeds (SEMENCES DE FRANCE) were seeded in a pot (500 ml) containing clay soil (predominantly used for sunflower and rapeseed crops).

Each seedling was sprayed with 0.5 mL of solution either containing, or not, an inoculum of 10⁹ CFU/ml of the Paraburkholderia graminis strain Bio T119, the Mitsuaria noduli strain Bio T025 (CNCM I-5724), or the Mitsuaria noduli strain. Bio T027 (CNCM I-5725).

Cultivation was then carried out in a greenhouse for 8 weeks. At the end of this period, the aerial dry matter and root dry matter percentages were determined for each plant. The results are presented in Table IV.

TABLE IV

| | Aerial dry | Root dry |
|---|---|---|
| Inoculum | matter (%) | matter (%) |
| — | 100 | 100 |
| Paraburkholderia graminis Bio T119 | 121.05 | 121.04 |
| Mitsuaria noduli Bio T025 | 136.8 | 105.26 |
| Mitsuaria noduli Bio T027 | 194.7 | 178.94 |

The results demonstrate that each of the three strains tested had an effect on yield. However, the inoculum of Mitsuaria noduli Bio T027 allowed for very significant improvement in yield, which was accompanied by improved rooting.

4) Improved Flowering of Sunflower Plants Under Water Stress Resulting from Mitsuaria noduli Inoculation

Sunflower seeds of the Naturela variety (CAUSSADE SEMENCES) were coated or not with a concentration of 105 CFU/seed of either the Paraburkolderia graminis strain Bio T119 or the Mitsuaria noduli strain Bio T025 (CNCM I-5724).

These seeds were then planted in microplots in Charente during periods of water stress over a period of 5 months.

Flowering was determined at harvest and the results are presented below in Table V.

TABLE V

| | Flowering |
|---|---|
| Inoculum | homogeneity |
| Control | 6.5 |
| Paraburkholderia graminis Bio T119 | 8.5 |
| Mitsuaria noduli Bio T025 | 7.3 |

It should be noted that rainy periods occurred in August. These episodes allowed a significant catch-up in flowering for the control. However, despite this catch-up, the results demonstrate that the two strains tested each had an effect on flowering. Specifically, the M. noduli Bio T025 inoculum appears to improve flowering significantly.

1. A method for improving plant growth comprising a step of application to the plant's seed, soil, roots, or leaves by spraying a composition comprising at least one live bacterial strain belonging to the species Mitsuaria noduli.

2. The method according to claim 1, wherein said strain is the strain of Mitsuaria noduli deposited at the CNCM on Jul. 30, 2021, under the number I-5724 or I-5725.

3. The method according to claim 1, wherein the composition typically comprises from 10⁴ to 10¹² CFU/g or CFU/ml of Mitsuaria noduli.

4. The method according to claim 1, wherein it aims to improve the growth of plants under water stress.

5. The method according to claim 1, wherein it aims to improve the yield of rapeseed, strawberries, or basil.

6. The method according to claim 1, wherein it aims to improve the nutrition of the strawberry plant.

7. The method according to claim 1, wherein it aims to improve sunflower flowering.

8. The method according to claim 1, wherein it aims to improve the rooting of rapeseed.

9. A use of a bacterial strain belonging to the Mitsuaria noduli species as a biostimulant.

10. The use according to claim 9, wherein said strain is the strain of Mitsuaria noduli deposited at the CNCM on Jul. 30, 2021, under the number I-5724 or I-5725.

11. A strain of Mitsuaria noduli deposited at the CNCM on Jul. 30, 2021, under the number I-5724 or I-5725.

12. A composition intended to improve plant growth comprising at least one strain as defined in claim 11.
